(19) United States
(12) Patent Application Publication
(10) Pub. No.: US 2007/0272862 A1
(43) Pub. Date: Nov. 29, 2007

(54) Method and Device for Remotely Communicating Using Photoluminescence or Thermoluminescence

(76) Inventors: Robert Desbrandes, Givarlais (FR); Daniel Lee Van Gent, Baton Rouge, LA (US)

Correspondence Address: E-QUANTIC COMMUNICATIONS, 1, ALLEE DES CHERINIERS, GIVARLAIS, FR-03190, FR

(21) Appl. No.: 11/569,357

(22) PCT Filed: May 23, 2005
(86) PCT No.: PCT/EP05/52348

§ 371 Date: Nov. 18, 2006

(30) Foreign Application Priority Data
May 26, 2004 (FR) 0405717
Apr. 12, 2005 (FR) 0503659

(51) Int. Cl. G01T 1/11

(52) U.S. Cl. 250/337

(57) ABSTRACT

The described method and device serve to remotely communicate or control by using photoluminescent or thermoluminescent molecules. A number of samples containing the photoluminescent or thermoluminescent molecules are irradiated simultaneously and together by gamma, X, ultraviolet or visible rays emitted in a cascading manner from an atomic source or from the target of a linear particle accelerator or of a nonlinear crystal. When the samples are separated, one of them is stimulated, i.e. the master, by a conventional method of infrared or white illumination or by heating, and the partially correlated luminescence of the other(s), i.e. the slaves, is measured. No method exists for interfering between the master and slaves. The slave(s) is/are the only one(s) that can instantaneously receive the signal of the master across all media and at all distances. The method and devices are provided, in particular, for use in communications or control applications.

### TECHNICAL FIELD

Certain crystals become excited when they are illuminated by a beam of particles, or radiation gamma, x-rays, white or ultraviolet light. These crystals can be of organic or mineral nature. Their deexcitation can occur immediately in the case of the photoluminescence or be delayed in the case of thermoluminescence. Two kinds of excitation are possible: the molecules can be excited in form of vibrations in the case of the photochemistry or in the form of electrons of valence ejected and trapped in impurities or dislocations of the crystal lattice in the case of the photoluminescence and thermoluminescence.

Photochemistry is generally brought forth with samples in liquid form whereas the photoluminescence and thermoluminescence generally occur with samples in solid form. In ultraviolet photochemistry the energy of the ultraviolet photons is transferred to molecules. According to Einstein law, only one photon excites only one molecule. Consequently, in the collision, the photon is completely absorbed by the molecule and the acquired energy is equal to the energy of the photon. This energy is stored in form of vibrations. The lifespan of the excited state is relatively short and varies from a few nanoseconds to a few seconds.

In photoluminescence, the energy of the photons of white or ultraviolet light is transferred to the valence electrons of the molecules, said electrons are captured by the impurities or dislocations of crystal lattice. The deexcitation due to the return of the electrons to their orbit of valence is brought forth at ambient temperature with a visible emission of radiation. The lifespan of the excited state varies with the type of molecule, the type of impurities or dislocation, and the temperature. The most current crystals contain molecules of Zinc sulfide or Strontium aluminate. They are generally doped with metal traces such as Calcium, Bismuth, Copper, Manganese, Europium or Dysprosium to obtain various colors of luminescence. The concentration in doping atoms generally varies from 10 to 1000 parties per million. Table 1 indicates the main crystals used in photoluminescence. These crystals are used and marketed in particular in the luminescent light signals. The photoluminescence thus obtained is different from the phosphorescence, generally obtained by doping the Zinc sulfide crystals with traces of a radioactive product such as Uranium. In this case, luminescence is brought forth without preliminary excitation by an ultraviolet or visible radiation.

Thermoluminescence is a physical phenomenon which results in the property that have certain crystals to emit some light when one heats them as curves (1) and (2) of FIG. 1 shows it. This luminescence is taking place only if the heating was preceded by an irradiation due ionizing radiations, for example with the exposure to natural radioactivity during thousands of years or to the exposure to an artificial source of gamma, X, alpha, beta, neutron, ultraviolet ray or visible radiation, during a few minutes or a few hours.

Thermoluminescence is used for dating in geology and archeology according to the following principle: since its firing, a ceramics accumulates an archaeological dose due to the natural irradiation. The annealing in laboratory of a sample of powder makes it possible to measure the duration of irradiation from the quantity of emitted light. If the sample is heated a second time it does not emit any more light unless it has received a new dose of irradiation meanwhile.

The fundamental equation of the dating by thermoluminescence is given by
ATL=DARG/DA
ATL is the age in years,
DARG is the archaeological or geological dose,
DA is the annual dose.

The archaeological or geological dose, DARG, are the quantity of energy of thermoluminescence per unity of mass stored by the crystal since its last heating. This quantity of energy is expressed in Gray (1 Gy=1 J/kg). It comes from the disintegration of the radioactive elements contained in the crystal and its environment. The archaeological dose is given by comparing the natural thermoluminescence of the crystals with that induced in laboratory by a known dose coming from a calibrated radioactive source.

Annual dose DA is the quantity of energy of thermoluminescence per unity of mass accumulated in one year by the crystal, and is also expressed in Gray. The annual dose is generally deduced from the concentrations in radio elements of the sample and the medium of burial.

The curve (1) of FIG. 1 represents the typical response of a stalagmitic calcite sample due to the rise in temperature. In the geological or archaeological applications, thermoluminescence measures the period elapsed since the last heating, which does not necessary correspond to the event to be dated (manufacture for the terra cotta, last use for a furnace, etc). Fires, restoration using a heating source, can distort the interpretation of the experimental results. The material must contain thermoluminescent crystals, which are sufficiently sensitive to irradiation (e.g.: quartz, feldspars, zircons, etc). The crystals should not be saturated with energy because their “storage capacity” limits the use of the technique. The oldest ages obtained until now are about 700,000 years. In archaeological dating, the samples should not have undergone any artificial irradiation (X, gamma, neutrons and other ionizing radiations) before the analysis by thermoluminescence.

Thermoluminescence is also used to determine the doses of ionizing radiation that occur in a given place. These doses can be measured in a laboratory or on an individual to ensure the safety in the use of the ionizing radiations. The technique is called “dosimetry by thermoluminescence”. Certain crystals, like Lithium fluoride (LiF), Calcium fluoride (CaF₂), Lithium borate (Li₂B₄O₇), Calcium sulfate (CaSO₄), and Aluminum oxide (Al₂O₃), activated by traces of transition metal, rare earths or Carbon, have the property to be excited under the influence of ionizing radiations. They become luminescent by heating and the dose of ionizing radiation can be calculated. At the time of the rise in temperature of irradiated samples of Aluminum oxide doped with Carbon (Al₂O₃: C), for example, the luminescence starts around 125° C. and reaches a maximum around 200° C. as shown in FIG. 1, curve (2). The rise in temperature by heating can be replaced by an exposure to the radiation of a laser, for example infrared.

Luminescence at ambient temperature is not strictly null and the excitation disappears slowly (fading, decrease of the obtained signal with time). In the same way a reverse fading is brought forth in the samples stored for a long time because they are slightly irradiated by the cosmic rays, and the ambient nuclear radiation. There is thus, in this case an increase in excitation. The decrease of intensity due to fading is, for example, about 3% in 3 months for the Aluminum oxide crystal doped with Carbon and at ambient temperature. The half-life of such a sample initially irradiated is thus approximately 5 years, i.e. the intensity of its luminescence decreases of one half in 5 years.

Glass borosilicate can also be used as a thermoluminescent material. Indeed, this normally transparent glass has the property of becoming opaque and of chestnut color when irradiated by ionizing radiations. Heated at 200° C., it loses its coloring gradually. Its half-life at the ambient temperature is about 10 years.

The phenomena of photoluminescence and thermoluminescence are explained by the imperfect structure of the crystals, which always contain a high number of the defects, either due to network defects, such as gaps or dislocations, or due to the presence of foreign atoms in the basic chemical composition (impurities), or due to atoms of doping. The energy received by the electrons of the crystal during the irradiation changes their energy levels.

In the band theory, valid for the photoluminescence and thermoluminescence, one explains the phenomenon with the following sequence:
Ionization by radiation releases the electrons in the valence band and holes are formed; the electrons are projected in the energy continuum of the conduction band.
The electrons are captured by traps consisting of impurities or dislocations of the network of the crystal in the forbidden band and the electrons are then in a metastable state.
This metastable state can last from a few microseconds to billion of years.
Calorific or optical energy applied to the crystal makes it possible for the electrons to leave the traps. The electrons return then in the valence band by emitting photons, which produce thermoluminescence.

The same phenomenon is taking place with the photoluminescence without the contribution of calorific energy besides the energy due to the temperature. The return towards the valence band can however occur without radiation, by internal conversion. The photoluminescent or thermoluminescent materials can be re-used. Fading is explained by the tunnel effect of the electrons, which have a low probability, but all the same a definite probability, to cross the barrier of potential, which enables them to leave the traps. For example, the photoluminescence can be interpreted like an important fading.

Fading is given by the equation:
Tau=A exp (E/kT)

where:
Tau is the average time that the electron stays in the trap,
A is a constant depending on material,
E is the difference in energy between that of the trap and that of the conduction band,
k is the Boltzmann constant,
T is the absolute temperature of the material.

In the case of materials used in dosimetry for example, for a shallow trap, E=0.034 eV, and for a deep trap E=0.042 eV. When T reaches 120° C. (393 K), kT=0.034 eV and the shallow traps are emptying. When T reaches 220° C. (493 K), kT=0.042 eV and the deep traps are emptying.

The electrons in both cases emit, while regaining their valence orbit, visible photons with an energy going from 1.8 eV to 3 eV (690 nm with 410 nm), according to which photoluminescent or thermoluminescent material is used.

It is known to the expert, in particular for nuclear safety, that the heating of the irradiated thermoluminescent samples can be carried out in various manners, for example, with electric resistance, or using the infra-red or visible radiation of a laser, which allows a fast heating and a better signal to noise ratio on small samples or on sample portions of material.

The difference in temperature of the peak of luminescence between minerals and materials used in dosimetry comes from the type of traps. In minerals, the traps are generally deep and in materials of dosimetry the traps are generally shallow. More calorific or optical energy is thus necessary to give energy to the electrons of deep traps. In photoluminescence, the traps are very shallow and they empty at the ambient temperature under the action of the network vibrations. This explains the variations of luminescence with the temperature.

Table 2 contains a list of the main substances used in thermoluminescence with their main characteristics: chemical formula, temperature for which the maximum of the signal is reached, wavelength of the emitted photons, saturation in energy, and fading (decrease of the signal obtained with time).

The natural substances generally have a long lifespan and consequently a very weak fading, this is the result of deep traps. The data published vary because these natural materials contain impurities in variable quantity and nature. Nevertheless, these materials can be used within the framework of this invention in their natural state or in an artificial form containing the same elements.

The artificial substances generally have a short lifespan and consequently an important fading which corresponds to shallow traps from where the electrons can be ejected more easily. The lifespan of these substances also allows their use in this invention either in photoluminescence or in thermoluminescence.

The very sensitive thermoluminescent substances obtained artificially can also be excited by ultraviolet rays or visible just like the photoluminescent substances. In this case the traps are not very deep and a stimulation by infrared rays is possible.

Former Technique:

The properties of photoluminescence are used for the light signals, which are excited during the day and that become luminescent at night.

The properties of thermoluminescence are used primarily for the geological and archaeological dating. In dosimetry, the properties of thermoluminescence are used for the protection against nuclear ionizing radiation and ultraviolet, the environmental nuclear monitoring, and the determination of accidental nuclear pollution or past military pollution.

Disclosed Invention:

The present invention describes a method and an apparatus to remotely communicate or control by using the photoluminescence or thermoluminescence. In this invention, it is made use of the photoluminescence or thermoluminescence having at least an excited state obtained by bombardment, irradiation or illumination by means of at least one source emitting directly or indirectly groups of entangled elementary particles such as:
entangled photons gamma, X, or ultraviolet or visible rays,
entangled electrons, entangled positrons, entangled protons, entangled atoms, entangled molecules, entangled micelles,
or of the combinations or the ensembles of these particles,

For example, in the case where entangled photons are used, the photoluminescence or thermoluminescence is caused by an irradiation or an artificial illumination of two or several samples of one or more photoluminescent or thermoluminescent materials previously mentioned, using an ionizing radiation composed of groups of particles such as entangled photons resulting directly or indirectly from a source.

Each group of entangled photons is made up of emitted photons together or at very short intervals by the same particle of the source, for example: electron, nucleus, atom, molecule. The sources of ad hoc entangled photons usable for this invention are, for example:
Natural or artificial radioactive materials producing a radiation in a cascade. For example, the Cobalt 60 atom emits almost simultaneously two gamma which are entangled and which can be used to irradiate a photoluminescent or thermoluminescent material.
Targets bombarded by particles such as electrons, protons, etc, which emit entangled photons by Bremsstrahlung effect. For example, in the accelerators of electrons which bombard targets, for example of Tungsten or phosphorescent glasses, groups of entangled photons gamma, X, ultraviolet rays or visible are produced by the phenomenon of Bremsstrahlung.
Materials containing atoms excited by the heat, which causes emissions of photons in a cascade. For example, the Mercury lamps emit groups of entangled ultraviolet photons and as such can be used to irradiate or illuminate a photoluminescent or a thermoluminescent material.
Nonlinear crystals which, when they are excited by an ad hoc laser beam (“pump”), produce two new divergent beams (“signal” and “idler”) of low power. These new beams are completely or almost completely entangled, i.e. each photon of one beam is entangled with a photon of the other beams. For example, BBO crystals made up of beta Barium borate (beta-BaB₂O₄) can emit two beams of groups of ultraviolet or visible entangled photons which can be used to irradiate or illuminate a photoluminescent or a thermoluminescent material.

Note: it is necessary to distinguish the bombardment of a target employed in Bremsstrahlung effect to produce entangled photons, from bombardment by entangled particles of photoluminescent or thermoluminescent material.

In this invention, the photoluminescent or thermoluminescent material samples are simultaneously bombarded, irradiated, or illuminated, by entangled particles, in particular, with the entangled photons coming from one or more of the ad hoc sources mentioned above, for a length of time depending upon the optimization of the process, the sources producing groups of two or several entangled photons. In the bombardment, the irradiation or the illumination, only the entangled particles distributed on two or several samples, of which each of them has excited a trap, are useful for the quantum coupling because the entanglement is transferred from the particles to said traps. In the specific case of a beam of particles common to both samples, the quantum couplings obtained are partial in that some of the entangled traps are localized on the same sample, and others are distributed on several samples. In the case where two separate entangled beams are produced, for example with nonlinear crystals of BBO type, an optimization of the method consists in directing a beam towards one of the samples and the other beam on the other sample. Consequently, the entanglement of the samples is complete or almost totally complete. Surfaces of the samples on which the process is implemented can go from 100 square nanometers to one square meter according to the optimization of the method used and technologies employed.

The present invention makes use of a phenomenon provided for by Quantum Mechanics according to which two or several entangled particles, in this invention the trapped electrons, preserve a quantum coupling when they are separated by any distance, quantum coupling which is practically instantaneous. Consequently, the deexcitation of one causes the deexcitation of the other or others. This quantum coupling can be transferred from particle to particle by interaction. In the case of photoluminescent or thermoluminescent materials, the quantum coupling is transferred from the entangled particles such as photons to the electrons of the valence band and are captured thereafter in the traps. The deexcitation of the electrons in the traps (called stimulation thereafter) causes an emission of visible photons (phenomenon of luminescence). In the case of quantum coupling between two trapped electrons, the stimulation of one electron also causes the correlated deexcitation of the other electron, which causes an emission of visible photons (phenomenon of luminescence). This luminescence, correlated with stimulation, is measured by a sensor, for example, photomultipliers, or photodiodes, or other sensors.

Many articles and books exist on the subject of the entanglement. The main ones are listed at the end of the description.

The photoluminescent or thermoluminescent material samples, after bombardment, irradiation, or illumination by groups of entangled particles, as described above, are then separated in space. In the case of two entangled samples, one the sample, the “master” is stimulated and the luminescence of the other, the “slave”, is measured. Several ad hoc techniques can be used to exploit the quantum couplings between samples. For example in thermoluminescence two techniques by heating and two optical techniques are used to stimulate the master sample:
The master sample can be heated on its totality by means of an external device or internal action, for example by a resistance, a beam of infrared, visible, or ultraviolet light, or by the phenomenon of induction of elements incorporated in the sample, which causes a variation of its luminescence and also a partially correlated variation of the luminescence of the slave sample, which is measured on the aforesaid whole slave sample or part of said slave sample. In this case, all the traps can be emptied completely. In particular this technique can be implemented for the deep traps.
The master sample can be heated in a point of its surface, for example by the convergent beam of a lens or by a laser beam of infrared, visible or ultraviolet, light which causes the heating of this point and a variation of its luminescence and also a partially correlated variation of the luminescence, due to the deexcitation of the corresponding entangled electrons of the traps located on the totality of slave sample, which is measured on of the whole or part of the aforesaid slave sample. The traps of the point heated of master sample are in general emptied completely and part of the traps of slave sample are emptied. Multiple measurements can be made on one group of entangled samples. In particular this technique can be implemented with the deep traps.
The master sample can be very briefly illuminated in its totality, for example by a flash of infrared, visible or ultraviolet light, which causes the emptying of some traps with a variation of luminescence, and also a partially correlated variation of the luminescence of the slave sample which is measured on the whole or part of the aforesaid slave sample. A great number of measurements can thus be made since few traps are emptied with each flash. In particular this technique can be implemented for the shallow traps. However, some deep traps can be transferred towards shallow traps by photonic stimulation.
The master sample can be very briefly illuminated on a small party of its surface, for example by a flash of infrared, visible or ultraviolet light of a laser or of a convergent lens, which causes the emptying of some traps of the aforesaid small surface of the master sample with a variation of luminescence, and also a partially correlated variation of the luminescence of the slave sample which is measured on whole or part of the aforesaid slave sample. A great number of measurements can thus be made on each small surface since a few traps are emptied with each flash. In particular this technique can be implemented with shallow traps. However, the deep traps can also be transferred towards shallow traps by photonic stimulation.

In a specific mode of optimization of the preceding optical techniques of stimulation, the master sample and/or the slave sample can be carried out at a controlled temperature, for example constant, ranging between 0° C. and 200° C. in order to facilitate the emptying of the traps of the samples during the measurement of the luminescence of the slave sample.

For example in photoluminescence, two optical techniques are usable to stimulate the master sample:
The master sample can be very briefly illuminated in its totality, for example by a flash of infrared, or possibly visible or ultraviolet, which causes the additional emptying of some traps with a variation of luminescence, and also a partially correlated variation of the luminescence of slave sample which is measured on whole or part of the aforesaid slave sample. A great number of measurements can thus be made since few traps are emptied with each flash.
The master sample can be very briefly illuminated on a small part of its surface, for example by the flash of infrared light, or possibly visible or ultraviolet light, of a laser or of a convergent lens, which causes the additional emptying of some traps of the aforesaid the small surface of the master sample with a variation of luminescence, and also a partially correlated variation of the luminescence of the slave sample which is measured on whole or part of the aforesaid slave sample. A great number of measurements can thus be made on each small surface since few traps are emptied with each flash.

In thermoluminescence and photoluminescence, the described techniques above can be used to transmit one or more information between one or more entangled master samples and one or more slave samples. In a specific mode of the invention, the entangled samples can be successively master for at least a sample and slave for at least another, then conversely, to carry out a communication in semi-duplex without leaving the framework of the invention. In a specific mode of the invention, the entangled samples, for example composed of several thermoluminescent materials exploited by optical stimulations, can be simultaneously masters and slaves to carry out a communication in duplex without leaving the framework of the invention. When the technique allows several measurements on the same group of entangled samples, it can be used either to communicate secure information, or to successively communicate several information without having to implement a device of synchronization of the reading head of the sensor of luminescence located on whole or part of slave sample. The single sensor of luminescence can be replaced by two or several sensors of luminescence located on whole or part of slave sample. The combinations of the techniques of stimulation and measurement described above can be implemented without leaving the framework of the invention. A sample or a “small surface” of the aforesaid sample, such as employed above, can contain from a few traps to a very great number, according to the optimization of the method used and technologies of stimulation and measurements employed. The number of traps necessary to the transmission and the reception of information takes account of the fading, inverse fading, and the sensitivity and precision of the apparatuses of irradiation or illumination and of the apparatuses of luminescence detection.

The traps of certain photoluminescent or thermoluminescent complex materials can be emptied by internal conversion and not emit luminescence during stimulation. In this case, the signal appears by a change of the intensity of fading.

The samples bombarded, irradiated or illuminated can be transported to long distances and, in particular in the case of thermoluminescence, can wait long periods while being always likely to be stimulated. In a specific mode of the invention, at least an entangled sample can be preserved at a very low temperature ranging between −273° C. and 20° C. in order to minimize fading, which prolongs the time of utilization of the sample. The traps have a half-life, which can extend from a nanosecond to 4.6 billion years.

According to the theory of Quantum Mechanics there is no known method of interference between a master and a slave. The slaves are the only ones being able to receive the signals of the masters, which allow implementations of the communication of key elements of cryptography, or codes of activation.

The method, purpose of the invention, are described above in its principle on two photoluminescent or thermoluminescent material samples, the “master” and the “slave”, prepared according to the methods described for the phase of bombardment, irradiation or illumination, and exploited according to the described techniques of stimulation and measurement of luminescence.

The method, purpose of the invention, can also be implemented to more than two samples prepared according to the described methods for the phase of bombardment, irradiation or illumination, without leaving the framework of the invention: according to the method employed, the samples present quantum couplings between them or sub-assemblies of these samples. For examples:
if samples are placed under a common beam, then they contain quantum couplings statistically distributed such that each sample can communicate with all the others, each sample having the capacity to be master or slave.
if K samples E1ₖ (K ranging between 1 and K) are placed under an entangled beam F1, and M samples E2ₘ (m ranging between 1 and M) are placed under the other entangled beam F2, the E1ₖ samples have each quantum couplings statistically distributed with the E2ₘ samples so that each E1ₖ sample can communicate with each E2ₘ sample and that each E2ₘ sample can communicate with each E1ₖ sample. On the other hand, the E1ₖ samples cannot communicate between them and the E2ₘ samples cannot communicate between them. These properties can be exploited for ad hoc and secure “point to multipoint” or “multipoint to multipoint” communications.

Generalization with the use of N entangled beams (N being from 1 to 999), for example obtained by means of successive splittings of beams by several BBO crystals, does not leave the framework of the invention. In the same way, the use of a stimulation modulated in amplitude and/or frequency of one or more master samples to communicate a luminescence variation partially correlated with one or more slave samples, does not leave the framework of the invention. Finally the extension of the method on two or several groups of entangled samples placed on one or more supports, exploited simultaneously or successively, by means of one or several implementations of the apparatuses, purposes of the invention, neither leave the framework of the invention.

The groups of master samples or slaves samples are generally solids made of photoluminescent or thermoluminescent material, natural or artificial crystals, placed on a support or incorporated in, or between, other materials. These crystals can also be used in various chemical or physical forms, for example in a powder form.

A group of entangled samples can contain samples in different physical and/or chemical forms. A group of entangled samples can also contain samples of which one at least underwent a physical and/or chemical transformation after bombardment, irradiation or illumination. The photoluminescent or thermoluminescent materials are, for example, selected among those listed in tables 1 and 2. Other photoluminescent or thermoluminescent, natural or artificial crystals, can be used without leaving the framework of the invention.

The samples of the same group can be of different natures, for example one can be in powder and the other can be in a film. A mixture of several photoluminescent or thermoluminescent materials of different nature can also be used.

The irradiation of the samples can be made with any type of generator of ad hoc entangled particles and the detection of the correlated luminescence of the “slave” samples can be measured with any type of suitable detector. The stimulation of a “master” sample can be implemented by any type of adapted source of infrared light, visible light, ultraviolet light or an adapted calorific source.

It is also possible that progress of the techniques allows for the use of instruments more sophisticated than those known at present and it is also possible that progress will improve the performances mentioned in this invention without leaving the framework of the invention. An amplitude modulation of stimulations can be used to send a message. More complex modulations such as frequency and/or amplitude modulation of stimulations can also be used.

One can stimulate specific materials, if a mixture of materials is used, by one of the following techniques of stimulation:
the heating which implements vibrations of the crystal lattice in the form of phonons of energy (k T), k being the Boltzmann constant and T the absolute temperature. This technique is macroscopic. FIG. 1 and tables 1 and 2 show for example that the listed materials present different responses in temperature with emission of photons of different wavelengths for each photoluminescent or thermoluminescent material. Consequently, the master sample containing a mixture of photoluminescent or thermoluminescent materials can be stimulated according to a particular curve of variation of the temperature versus time. Consequently, one or several slave samples containing the same mixture of photoluminescent or thermoluminescent materials, or another mixture in known proportions, present then a spectrum of emissions of photons in wavelengths and amplitude varying in time, which makes it possible to improve the signal to noise ratio of the transmission.
the optimized radiation, for example provided by a laser of infrared, or possibly visible or ultraviolet light, which emits photons of energy (hv), h being the Planck's constant and v being the frequency of the photon. The radiation is optimized in frequency, intensity and duration for each photoluminescent or thermoluminescent material. The spectral response of the material or the mixture of materials used is characteristic. Slave samples containing the same mixture of photoluminescent or thermoluminescent materials that the master sample, or another mixture in known proportions, present then a spectrum of emissions of photons in wavelengths and amplitudes versus time, which makes it possible to improve the signal to noise ratio of the transmission. In a specific mode of the technique of optimized radiation, at least one sample can be maintained at a low temperature (ranging between −273° C. and 20° C.) in order to eliminate the secondary effect from the phonons due to heat, and thus to obtain a spectrum of emissions of photons whose characteristic lines are better defined. The technique of optimized radiation can be exploited up to microscopic level, and in particular in nanotechnology, either on the level of the entangled samples, or on the level of the small surfaces illuminated in the aforementioned entangled samples. The recursion of the phases of stimulation/measurement can be much higher in these techniques making it possible to reach a great flow of emitted and received information.

### SUMMARY DESCRIPTION OF THE DRAWINGS

FIG. 1 represents the response of luminescence during the heating of two thermoluminescent samples.

FIG. 2 schematically represents the irradiation of two samples of a photoluminescent or thermoluminescent material with entangled gamma or X radiation or entangled ultraviolet or visible light.

FIG. 3 schematically represents the principle of the quantum coupling between the stimulated sample, the “master”, on the left and the receiving sample, the “slave”, on the right.

FIG. 4 illustrates a mode of implementation of the invention in which a plurality of samples is placed on two films that can be irradiated in a sequence and together by entangled gamma, or X rays produced by a generator, or with entangled ultraviolet or visible light.

FIG. 5 illustrates the use of films to communicate. On the left of the figure, signals are emitted with phase or amplitude modulation of the stimulation of the master sample. On the right, the signal coming from slave sample is detected by a photomultiplier or a photodiode.

FIG. 6 represents films unwound such as they are presented in front of the systems of stimulation and of detection.

FIG. 7 represents schematically two apparatuses: one, on the left, is used as a transmitter and the other, on the right, is used as a receiver. The functionalities can be reversed, allowing communications in semi-duplex.

FIG. 8 represents schematically two apparatuses: one, on the left, is used as a transmitter with one of the samples and the other, on the right, is used as a receiver on the totality of the other samples. This functionality allows simple communications without synchronization of the discs carrying the groups of entangled samples.

Table 1 enumerates the main photoluminescent materials available at present with their characteristics. Very many artificial materials exist with various atoms of doping or combinations of atoms of doping or dislocations.

Table 2 enumerates the main thermoluminescent materials available at present with their characteristics. Very many artificial materials exist with various atoms of doping or combinations of atoms of doping or dislocations. The data of this table are approximate since they are sometimes different according to the authors and the nature of the samples.

### MANNERS OF IMPLEMENTING THE INVENTION

Manners of implementing the invention are described below. However it is specified that the present invention can be implemented in various ways. Thus, the specific details mentioned below should not be understood as limiting the implementation, but rather as a descriptive basis to support the claims and to teach the expert the use of the present invention, in practically the totality of the systems, structures or manners, that are detailed and can be adapted.

According to a specific mode of the invention, two thermoluminescent or photoluminescent material samples, for example samples of oxide Aluminum doped with Carbon, are bombarded, irradiated or illuminated by entangled particles, for example by entangled gamma photons of a linear accelerator of type CLINAC (Compact Linear Accelerator), during a sufficient time to reach a dose close to saturation, roughly 10 Gray (J·kg⁻¹), and it takes generally a few minutes. These samples are then maintained in the darkness in order not to decrease the “fading”.

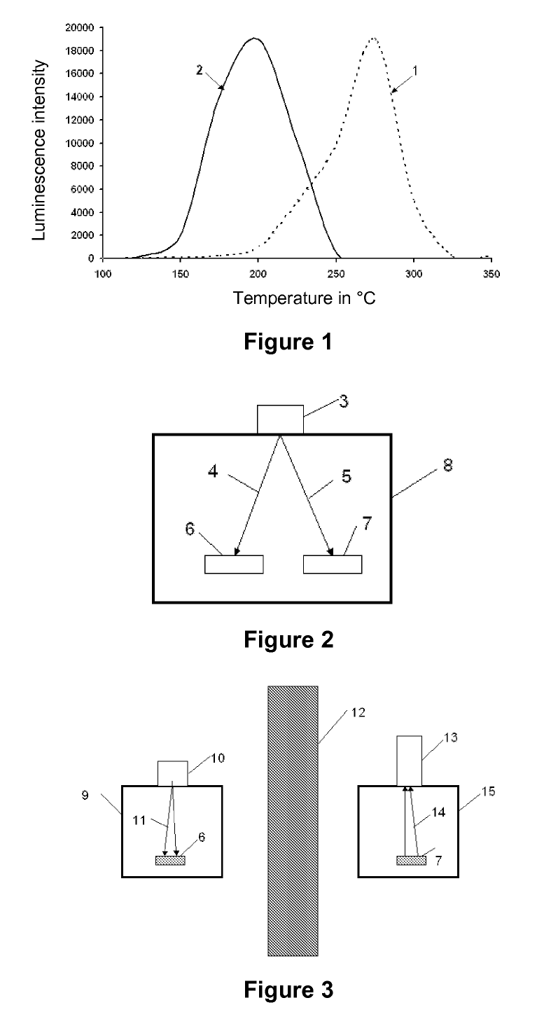

FIG. 2 schematically represents the irradiation of the two samples (6) and (7) by entangled ionizing radiation (4) and (5) in the obscure chamber (8). The source (3) can be of the CLINAC type, for example. In the case of photoluminescence, the entangled radiation (4) and (5) can be ultraviolet rays or visible light.

FIG. 3 schematically represents the experiment of a remote communication. A symbolic separation (12) represents any medium and distances between the transmitter on the left and the receiver on the right. The entangled sample (6), the “master”, is placed in the obscure chamber (9) of the transmitter. A lamp or a laser of infra-red, or possibly visible or ultraviolet light (10), illuminates with the radiation (11) and heats the sample (6). The heating can also take place with a resistance in particular in the case of thermoluminescent samples. The receiving system is also made of an obscure chamber (15). It includes the entangled sample (7), the “slave”, whose luminescence (14) illuminates a detector (13), for example a photomultiplier or a photodiode. A system, not represented, records the luminescence according to the temperature or the time. The implementation of the invention is more complex to allow the transmission and the reception of a succession of signals as indicated in the continuation.

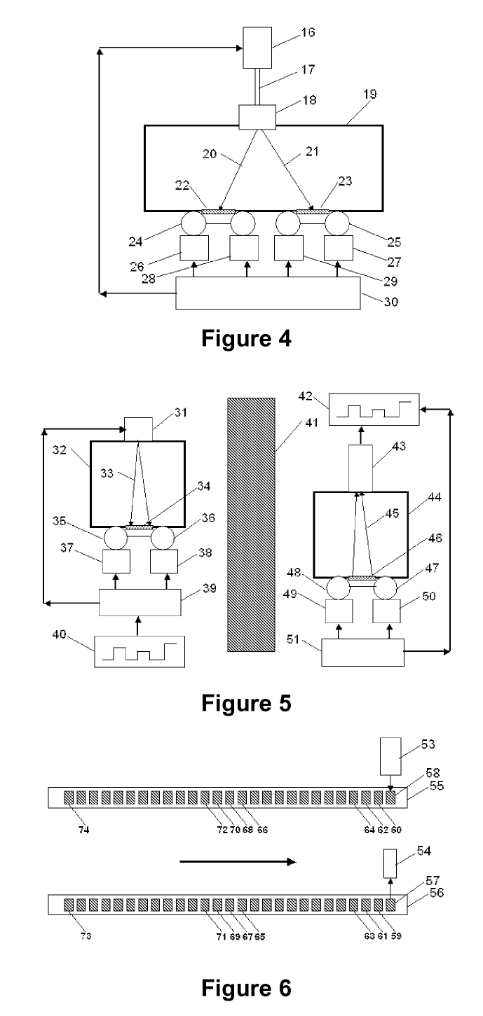

According to another specific mode of the invention, the bombardment, the irradiation or the illumination are represented on FIG. 4. The samples are presented, for example, in the form of a the Teflon film, which contains thermoluminescent or photoluminescent material. On this figure, a particle accelerator (16) directs towards on target (18) some accelerated particles (17), for example of electrons. In the obscure chamber (19), the entangled gamma rays, X-rays, ultraviolet rays or visible photons (20) and (21) are sent on thermoluminescent or photoluminescent films (22) and (23) for the irradiation of surfaces of any form, square, circles, or rectangles. They are named “frames” in the continuation. These frames will be presented in a synchronous way, one by one, and will stop the time necessary for the irradiation used to send and receive the messages. The films are rolled up in containers (24) and (25). The unwinding of films for the irradiation of each frame is ensured by the mechanisms (26) and (29). Rewinding can be done with the mechanisms (28) and (27). These mechanisms are controlled by a timer (30). This timer also controls the particle accelerator (16). A great number of correlated irradiations can be made in a sequence for each container. One of the containers contains “master” film, the other contains “slave” film The aforementioned containers are light tight like the containers of photography film.

According to the same mode of implementation of the invention, FIG. 5 represents the remote stimulation of the slave film. A symbolic separation (41) represents any medium and distances between the transmitter on the left and the receiver on the right. The left part of the figure represents the apparatus that causes the stimulation of the master samples (34), irradiated beforehand at the same time as the slave samples, to send messages. These samples coming from the film contained in the containers (35) and (36), are exposed in the dark chamber (32) to the radiation of infra-red, or possibly visible or ultraviolet light (33), coming from the source of light (31), for example of a laser. Mechanisms (37) and (38) ensure the unwinding of thermoluminescent or photoluminescent film. A timer (39) adjusts the operation of the mechanisms for unwinding the film frame by frame and the lighting of the source (31). The signals to be transmitted are provided by the generator (40) which controls the modulation of the intensity in amplitude and duration of stimulation for each frame.

The right part of FIG. 5 represents the signal receiver. A detector of luminescence, for example a photomultiplier or a photodiode (43), is placed in the wall of a dark chamber (44). It receives the luminescence radiation of luminescence (45) emitted by the frame (46) of a thermoluminescent or photoluminescent film. This film is contained in the containers (47) and (48), themselves actuated by the mechanisms (49) and (50). The timer (51) controls the mechanisms and the recorder (42). No communication is necessary for the synchronization of the emission and the reception because the receiver is put in watch on the first frame. When a signal appears, the sequence of presentation of the receiving frames starts at an agreed rate identical to that of the emitting system.

In another mode of implementation, the films can move simultaneously and continuously for the exposure to the entangled radiation as illustrated on FIG. 4. To carry out a telecommunication between a master film and a slave film as indicated on FIG. 5, the slave remains on watch on the beginning of the slave film. When a signal appears, the unwinding of the slave film is done at a speed identical to that of the unwinding speed of the master film. It is also possible to code the stopping of the slave film and its restarting. Of course, during all these measurements, it is taken account of the very weak natural decrease of the luminescence of the thermoluminescent or photoluminescent substances used.

The apparatuses described previously are examples of implementation. Other means to present the samples or films at the irradiation and detection can be employed without leaving the framework of the invention. In particular, the use of two separate beams of entangled particles, or entangled gamma rays, X rays, or ultraviolet or visible light, for the bombardment, the irradiation or the illumination is possible without leaving the framework of the invention.

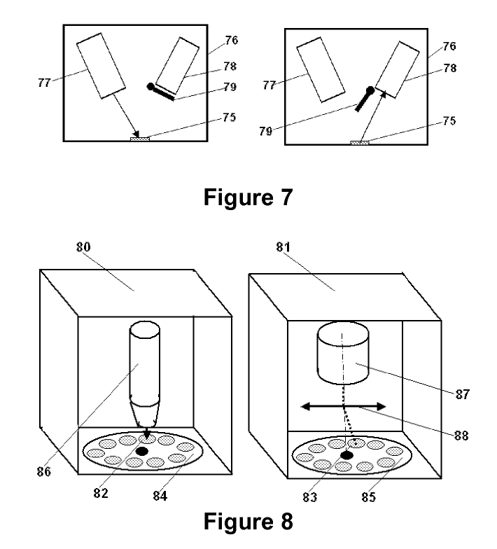

An example of film is illustrated on FIG. 6. On the film (55), the “master”, small surfaces (58), (60, . . . (74) and on the film (56), the “slave”, of small surfaces (57), (59), . . . (75), are irradiated two by two simultaneously and independently by separate beams of entangled particles two by two. The master and the slave can then separated by very long distances, through any mediums and the films being exploited as follows: each one being in a darkroom: the generator of photons of infrared, or possibly visible or ultraviolet light (53) strongly illuminates a small surface (58), a strong signal is then received by the detector of luminescence, for example a photomultiplier or a photodiode (54). A synchronized movement of two films is then started. The surfaces (60), (62), (64), . . . etc are then illuminated successively with various intensities and corresponding signals on surfaces (59), (61), (63), . . . etc are recorded. To stop the movement of films, for example, two strong illuminations in a sequence are applied on surfaces (66) and (68) of the master film. These strong signals are detected by the slave film in (65) and (67) and cause the stopping of the slave film. The restarting of films is done by a strong illumination on surface (70) causing a strong signal on surface (69) and the restarting of the slave film. New signals are transmitted with surface (72) and following corresponding to surface (71) and following. A strong signal on surface (74) received by surface (73) indicates the end of the message. This mode of very elementary implementation, can be implemented in a more complex way without leaving the framework of the invention. The films can be replaced by discs, small surfaces placed on one or more circumferences without leaving the framework of the invention. In the case of films as well as in that of discs, surfaces can be joined to form a long trace and the irradiation like the stimulation and detection can be done by continuous displacement of films or continuous rotation of the discs again without leaving the framework of the invention. The generator of photons of stimulation (53) and the detector of luminescence (54) on FIG. 6 can be regrouped in the same instrument as shown in the FIG. 7. The supports of thermoluminescent or photoluminescent materials bombarded, irradiated, or illuminated, beforehand made of, for example of films or discs, can then be used either as transmitters of signal or as receivers. A semi-duplex communication can thus be established. On FIG. 7, the enclosure (76) contains the generator of infra-red photons, or possibly visible or ultraviolet light for stimulation (77) and the detector of luminescence (78). They are oriented in way either to illuminate the surface (75) to stimulate it in emission mode as shown on the left, or to detect the luminescence of surface (75) in reception mode as shown on the right. This transmitter-receiver is normally put in watch in a reception mode (right part of the figure). It is used in emission mode only when a message must be sent. In emission mode (left part of the figure), an obturator (79) protects the detector from the luminescence.

When a confirmation of a transmitted information is required, two systems such as that described on FIG. 5 are used. For example, Alice and Bob have each one two films or entangled discs two by two, each one fitted with a generator of infra-red photon, or possibly visible or ultraviolet light, and of a detector of luminescence, for example a photomultiplier or a photodiode. Telecommunication between Alice and Bob can then be carried out in duplex.

FIG. 8 schematically shows another mode of exploitation of two supports, for example of the discs, containing entangled samples two by two. The disc master (84) is placed in the dark chamber (80). The sample (82), for example, is stimulated, for example, by the infra-red laser, or possibly visible or ultraviolet light (86). In the dark chamber (81) the entangled sample corresponding (83) of the slave support (85) produces a partially correlated variation of luminescence, which is measured through a convergent device, for example a lens (88), by the detector of luminescence (87). Said detector can receive the luminescence of any sample of support (85). Consequently, no synchronization between the two supports (84) and (85) is necessary in this implementation of the invention to transmit and receive a message. The elements (87) and (88) can be replaced by a numerical camera with several million pixels, making it possible to exploit information associated with the localization of the slave sample.

### POSSIBILITIES OF INDUSTRIAL APPLICATIONS

Various industrial applications are immediately possible: emergency signals in the mines, sea-beds, at interplanetary distances, etc

Devices according to the invention, including commercial kits of demonstration of the method, can consist of whole or part of the following apparatuses:
apparatuses of bombardment, irradiation or illumination of particles entangled as described above,
apparatuses of stimulation as described above,
apparatuses of detection of luminescence as described above.

Some of these apparatuses, in that they are intended to implement the method purpose of the invention, can be conceived, manufactured or assembled by the same company or different companies, or in the same place or different places, without leaving the framework of the protection sought by this patent insofar as the aforementioned apparatus are conceived, manufactured or assembled on the place of protection of this patent, including the aircraft, the marine, underwater and space vessels, and the terrestrial, marine and space probes.

Some of these apparatuses, in that they are intended to implement the method purpose of the invention, can be exploited by the same company or different companies, or in the same place or different places, without leaving the framework of the protection sought by this patent, insofar as at least one of these apparatuses is exploited on the place of protection of this patent, including the aircraft, the marine, underwater and space vessels, and the terrestrial, marine and space probes.

With thermoluminescent or photoluminescent materials of long lifespan, simple communications, one-way communications, semi-duplex or duplex communications, can be established. These communications can be detected only by the receiving samples. They are thus rigorously secret. They are also practically instantaneous and can be implemented through all mediums and at all distances.

### REFERENCES

[1] Einstein A., Podolsky B., Rosen N., <<Can Quantum-Mechanical Description of Physical Reality Be Considered Complete?>>, Phys. Rev. 47, 777, (1935)
[2] Bell J. S., <<Speakable and Unspeakable in Quantum Mechanics>>, New York, Cambridge University Press, 1993.
[3] Aspect A., <<Trois tests expérimentaux des inégalités de Bell par mesure de corrélation de polarisation de photons>>, Doctoral Dissertation, Université Paris-Orsay,1^{er} Février 1983.
[4] Townsend P. D., Rarity J. G., Tapster P. R., <<Single-Photon Interference in 10 km Long Optical-Fiber>>, Electronics Letters, V 29, p. 634, 1993.
[5] Duncan A. J., and Kleinpoppen H., <<Quantum Mechanics versus Local Realism>>, (F. Selleri, ed.), Plenum, New York, 1988.
[6] Richardson B. Coburn, and T. G. Chasteen T. G., <<Experience the Extraordinary Chemistry of Ordinary Things>>, John Wiley and Sons: New York, 2003, 343 pages.
[7] Weber M. J. and Tompson B. J. <<Selected Papers on Photoluminescence of Inorganic Solids>>, SPIE Milestone Series, V. Ms 150, August 1998.
[8] Pelton M. et al., <<Triggered single photons and entangled photons from a quantum dot microcavity>>, Eur. Phys. J., D 18, 179-190 (2002).
[9] Johnson B. D., <<Infrared Diode Laser Excites Visible Fluorophores>>, Photonics, December 2001.
[10] Compton K. <<Image Performance in CRT Displays>> (Tutorial Texts in Optical Engineering, Vol. TT54), SPIE, January 2003.
[11] Sergienko A. V., and Jeager G. S., <<Quantum information processing and precise optical measurement with entangled-photon pairs>>, Contemporary Physics, V. 44, No. 4, July-August 2003, 341-356.
[12] Greenberger D. M., Horne M. A., and Zeilinger A., <<Multiparticle Interferometry and the Superposition Principle >>, Physics Today 46 8 (1993).
[13] Blinov B. B., et al, <<Observation of entanglement between a single trapped atom and a single photon>>. Nature, 428, 153-157, (11 Mar. 2004).
[14] Julsgaard B., Kozhekin A., and Polzik E; S., <<Experimental long-lived entanglement of two macroscopic objects>>, Nature, 413, 400-403,(2001).
[15] Justus B. L. et al., <<Dosimetry measurements>>, CRC Press LLC,(2000).
[16] Shani G., <<Radiation Dosimetry: Instrumentation and Methods>>, CRC Press (January 2001).
[17] Botter-Jensen L., McKeever S; W; S., and Wintle A; G., <<Optically Stimulated Luminescence Dosimetry>>, Elsevier, Amsterdam, NL, (2003).
[18] McKeever S. W. S., <<Thermoluminescence of solids>>, Cambridge University Press, 1985.
[19] Furetta C., <<Handbook of Thermoluminescence>>, World Scientific Publishing Company (Mar. 1, 2003).
[20] Greenberger D., et al,. <<Bell's Theorem Without Inequalities>>, Amer. J. of Phys., 58, (12), December 1990.
[21] Smith A., V., <<How to select non linear crystal and model their performance using SNLO software>>, SLNO software from Sandia National Laboratory. (http://www.sandia.gov/imrl/XWEB1128/snloftp.htm)

Tables:

TABLE 1

| | | Peak of | Peak of | Visible | | Duration of |
|---|---|---|---|---|---|---|
| | Chemical | excitation | emission | luminescence | | excitation |
| Substance | composition | (nm) | (nm) | during | | (minutes) |
| SrS: Ca, Bi | SrS: Ca, Bi | 360 | 480 | 45 | days | 30 |
| ZnS: Cu | ZnS: Cu | 360 | 520 | 200 | min. | 4 |
| ZnS: Cu: Mn | ZnS: Cu: Mn | 360 | 640 | 600 | min. | 4 |
| SrAl + add. | Conf. | 360 | 640 | 45 | days | 30 |
| SrAl + add. | Conf. | 360 | 650 | 45 | days | 30 |
| SrAl + add. | Conf. | 360 | 670 | 45 | days | 30 |
| SrAl + add. | Conf. | 360 | 680 | 45 | days | 30 |
| SrAl + add. | Conf. | 360 | 580 | 45 | days | 30 |
| SrAl + add. | Conf. | 360 | 500 | 45 | days | 30 |

Add. for additive not revealed; Conf. For confidential.

TABLE 2

| | | Temperature | | | |
|---|---|---|---|---|---|
| | | of maximum | Wavelength | Saturation | Fading |
| Substance | Molecule | (° C.) | (nm) | Gray (J/kg) | (%/year) |
| Calcite | CO₃Ca: Impurities | 275 | | 120 | 0.001 |
| Natural quartz | SiO₂: Impurities | 370 | 370 | 1000 | 0.001 |
| | | | 460-560 | | |
| Quartz second cycle | SiO₂: Impurities | 110 | 560 | 400 | 5 |
| Doped molten quartz | SiO₂: Cu | 130-185 | 500 | 400 | 5 |
| Zircon | ZrSiO₄: Impurities | 300 | 365 | 100 | 0.001 |
| Potassic feldspar | Si₃AlO₉: K | 150-270 | 380 | 2000 | 0.03 |
| Borosilicate glass | SiO₂—B₂O₃—Al₂O₃ | 220 | 500 | 300 | 0.01 |
| | Na₂O: impurities | | | | |
| Aluminum oxide | Al₂O₃: C | 180 | 325-410 | 50 | 12 |
| Lithium fluoride | LiF: Mg, Cu, P | 155 | 410 | 1000 | 5 |
| Lithium fluoride | LiF: Mg, Cu, Na, Si | 230 | 410 | 1000 | 5 |
| Calcium fluoride | CaF₂: Mn | 285-390 | 340 | 1000 | 5 |
| Calcium sulfate | CaSO₄: Dy | 220 | 340-360 | 100 | 4 |

1) Simple product to communicate characterized in that it is made of a sample containing at least one kind of excited thermoluminescent materials having at least one metastable state that emits photons, called fading, and in that electrons present in traps of the aforesaid thermoluminescent materials, are entangled with electrons present in traps of one or more other samples, the aforementioned sample being called thereafter by convention the “entangled” sample, the said “entangled” sample having quantum couplings between some of its trapped electrons and some trapped electrons from one or more aforesaid other samples.

2) Simple product according to claim 1 characterized in that the aforementioned kind of thermoluminescent materials is one of the following materials: artificial materials such as: Aluminum oxide (Al₂O₃) doped with Carbon, Lithium fluoride (LiF) doped with Manganese, Coppers and Phosphorus, Calcium fluoride (CaF₂) doped with Manganese, Calcium sulfate (SO₄Ca) doped with Dysprosium, or of natural materials such as quartz (SiO₂), calcite (CO₃Ca), zircon (ZrSiO₄) containing impurities or dislocations, or counterparts of these natural materials, or glasses such as borosilicate glass (SiO₂,B₂O₃,Al₂O₃,Na₂O and impurities).

3) Manufacturing process of the simple product according to the claim 1 characterized in that one carries out at least the following steps:
(a) one prepares together samples containing at least one kind of thermoluminescent materials having at least one metastable state that emits photons, called fading,
(b) one proceeds to at least one of the following processes, called thereafter excitation process, either a bombardment, or an irradiation, or an illumination of the aforesaid samples by means of suitable particles for exciting said thermoluminescent materials, some of said particles belonging to groups of entangled particles transferring their entanglement to the corresponding valence electrons of the aforesaid thermoluminescent materials, by ejecting the said valence electrons towards the conduction band from which they are captured by traps of the aforesaid thermoluminescent materials, the said traps being distributed in the aforesaid samples produced together, qualified thereafter by convention as the set of “entangled” samples.

4) Manufacturing process according to claim 3 characterized in that the aforementioned entangled particles used for the aforementioned excitation process are made of at least one kind of the following photons that are suitable to excite the aforementioned kind of thermoluminescent materials, for example entangled gamma, entangled X, entangled ultraviolet or entangled visible photons, for example emitted either by a natural or artificial radioactive material composed of atoms emitting several photons in a cascade, or by a target bombarded by accelerated particles which emit groups of photons by Bremsstrahlung effect, or by a material made up of atoms emitting in a cascade by ionization, groups of entangled photons, or by a generator of groups of entangled photons emitting these groups of photons distributed in at least two separate beams and partially or almost completely entangled.

5) Manufacturing process according to claim 3 characterized in that the aforementioned entangled particles used for the aforementioned excitation process are made of at least one kind of the following massive particles that are suitable to excite the aforementioned kind of thermoluminescent materials, for example entangled electrons, entangled positrons, or entangled protons.

6) Manufacturing process according to claim 3 characterized in that the aforementioned excitation process is carried out by means of N separate beams which are completely, or almost completely, entangled N to N, a separate beam being applied to sub-assembly of aforementioned samples, forming by applying the method the a sub-assembly of “entangled” samples, each of said “entangled” sample having aforementioned quantum couplings with samples of the other sub-assemblies while not having quantum couplings with the other samples of the same sub-assembly, N going from 2 to 999.

7) Manufacturing process according to claim 3 characterized in that one uses aforementioned “entangled” samples of which one at least undergoes a physical and/or a chemical transformation after the aforementioned excitation process.

8) Method to transmit remotely an information or a command by utilizing the simple product according to claim 1 characterized in that one exploits aforementioned quantum couplings by causing at least one stimulation of deexcitation of the trapped electrons, called thereafter a stimulation, suitable for the aforementioned kind of thermoluminescent materials, applied on the aforementioned “entangled” sample, qualified thereafter as the “master” “entangled” sample, for example by heating it in its totality, or by heating it in at least a point of its surface, or by optical stimulation using at least one flash of infrared, visible, or ultraviolet light on its totality, or by optical stimulation using at least one flash of infrared, visible or ultraviolet light in at least one point of its surface, or by a combination of these methods, the aforesaid stimulation characterizing one information or one control to be remotely transmitted.

9) Method according to claim 8 characterized in that the aforementioned stimulation applied to the aforementioned “master” “entangled” sample is modulated in time and is optimized for at least one aforementioned thermoluminescent material.

10) Method according to claim 8 characterized in that the aforementioned stimulation by infrared, visible, or ultraviolet radiation applied to the aforementioned “master” “entangled” sample is optimized in energy of the photons for at least one kind of aforementioned thermoluminescent materials.

11) Method according to claim 8 characterized in that the aforementioned “master” “entangled” sample is stimulated by at least one beam, for example produced by a laser, in a point of the surface of the aforesaid “master” “entangled” sample, this point representing a surface of 100 square nanometers to one square centimeters.

12) Method according to claim 8 characterized in that the aforementioned stimulation applied to the aforementioned “master” “entangled” sample is modulated either at least in amplitude, or at least in time.

13) Method to receive a distant information or command by utilizing the simple product according to claim 1 characterized in that one exploits aforesaid quantum couplings by determining at least one detection of a distant information, or at least one detection of a remote control, by means of at least one measurement made with a detector of luminescence, for example a photomultiplier or a photodiode, of at least one variation of luminescence on at least one kind of aforementioned thermoluminescent materials contained in the aforementioned “entangled” sample, qualified as “slave” “entangled” sample.

14) Method according to claim 13 characterized in that the aforementioned “slave” “entangled” sample contains at least one kind of aforementioned excited thermoluminescent materials, whose luminescence contains a plurality of optical lines of which at least one is measured.

15) Method according to claim 13 characterized in that the aforementioned “slave” “entangled” sample is exploited at a low temperature ranging between −273° C. and 20° C. in order to eliminate the secondary effect of the phonons due to heat, and thus to obtain an emission spectrum of photons whose characteristic lines are better defined.

16) Complex product to communicate characterized in that a plurality of aforementioned “entangled” samples, each said “entangled” samples constituting a product according to claim 1, are laid out on a support, for example a disk, called thereafter by convention the “entangled” support, said “entangled” samples being positioned on said support according to a definite order, all or part of said “entangled” samples having each some quantum couplings with one or more other samples distributed on one or several other supports.

17) Device of excitation for the implementation of the method according to claim 3 for the manufacture of “entangled” supports according to claim 16 characterized in that it includes at least one apparatus of excitation providing the aforementioned excitation process to at least one set of aforementioned samples, which is the set of samples to be entangled, two at least of said “entangled” samples of said set of “entangled” samples being distributed on at least two supports, said process being successively repeated on a plurality of sets of samples to be entangled and distributed according to at least one definite order on said supports according to the optimization of the device, in order to produce the “entangled” supports.

18) Device of implementation of the method according to claim 8 applied to the complex product according to claim 16 characterized in that it includes at least one apparatus of stimulation made to apply aforementioned stimulation to at least one of the aforementioned “entangled” samples of the aforementioned “entangled” support to remotely transmit at least one information or one command.

19) Device of implementation of the method according to claim 13 applied to the complex product according to claim 16 characterized in that it includes at least one apparatus of detection of luminescence made for applying aforementioned measurement of at least one aforementioned variation of luminescence on at least one of the aforementioned “entangled” samples of the aforementioned “entangled” support to receive at least one distant information or one distant command.

20) Method of use of the complex product according to the claim 16 to remotely transmit and/or receive complex pieces of information, in particular emergency signals or control, elements of cryptographic keys, or codes of activation.

21) Simple product to communicate characterized in that it is made of a sample containing at least one kind of excited photoluminescent materials having at least one metastable state that emits photons, called fading, and in that electrons present in traps of the aforesaid photoluminescent materials, are entangled with electrons present in traps of one or more other samples, the aforementioned sample being called thereafter by convention the “entangled” sample, the said “entangled” sample having quantum couplings between some of its trapped electrons and some trapped electrons from one or more aforesaid other samples.

22) Simple product according to claim 21 characterized in that the aforementioned kind of photoluminescent materials is having one said metastable state of a half life of one nanosecond to 4.6 billion years, for example: artificial materials such as: Sulfide of Zinc doped with Copper (ZnS:Cu), Sulfide of Zinc doped with Copper and Manganese (ZnS:Cu:Mn), Sulfide of Strontium doped with Calcium and Bismuth (SrS:Ca:Bi), Aluminate of Strontium (SrAl₂O₄) doped with Calcium, Bismuth, Copper, Manganese, Europium, or Dysprosium.

23) Manufacturing process of the simple product according to the claim 21 characterized in that one carries out at least the following steps:
a) one prepares together samples containing at least one kind of photoluminescent materials having at least one metastable state that emits photons, called fading,
b) one proceeds to at least one of the following processes, called thereafter excitation process, either a bombardment, or an irradiation, or an illumination of the aforesaid samples by means of suitable particles for exciting said photoluminescent materials, some of said particles belonging to groups of entangled particles transferring their entanglement to the corresponding valence electrons of the aforesaid photoluminescent materials, by ejecting the said valence electrons towards the conduction band from which they are captured by traps by traps of the aforesaid photoluminescent materials, the said traps being distributed in the aforesaid samples produced together, qualified thereafter by convention as the set of “entangled” samples.

24) Manufacturing process according to claim 23 characterized in that the aforementioned entangled particles used for the aforementioned excitation process are made of at least one kind of the following photons that are suitable to excite the aforementioned kind of photoluminescent materials, for example entangled gamma, entangled X, entangled ultraviolet or entangled visible photons, for example emitted either by a natural or artificial radioactive material composed of atoms emitting several photons in a cascade, or by a target bombarded by accelerated particles which emit groups of photons by Bremsstrahlung effect, or by a material made up of atoms emitting in a cascade by ionization, groups of entangled photons, or by a generator of groups of entangled photons emitting these groups of photons distributed in at least two separate beams and partially or almost completely entangled.

25) Method to transmit remotely an information or a command by utilizing the simple product according to claim 21 characterized in that one exploits aforementioned quantum couplings by causing at least one stimulation of deexcitation of the trapped electrons, called thereafter a stimulation, suitable for the aforementioned kind of photoluminescent materials, applied on the aforementioned “entangled” sample, qualified thereafter as the “master” “entangled” sample, for example by heating it in its totality, or by heating it in at least a point of its surface, or by optical stimulation using at least one flash of infrared, visible, or ultraviolet light on its totality, or by optical stimulation using at least one flash of infrared, visible or ultraviolet light in at least one point of its surface, or by a combination of these methods, the aforesaid stimulation characterizing one information or one control to be remotely transmitted.

26) Method to receive a distant information or command by utilizing the simple product according to claim 21 characterized in that one exploits aforesaid quantum couplings by determining at least one detection of a distant information, or at least one detection of a remote control, by means of at least one measurement made with a detector of luminescence, for example a photomultiplier or a photodiode, of at least one variation of luminescence on at least one kind of aforementioned photoluminescent materials contained in the aforementioned “entangled” sample, qualified as “slave” “entangled” sample.

27) Method according to claim 26 characterized in that the aforementioned “slave” “entangled” sample is exploited at a low temperature ranging between −273° C. and 20° C. in order to eliminate the secondary effect of the phonons due to heat, and thus to obtain an emission spectrum of photons whose characteristic lines are better defined.

28) Method according to claim 26 characterized in that the aforementioned “slave” “entangled” sample is stored at a low temperature ranging between −273° C. and 20° C. in order to minimize fading, which prolongs the service time of said “entangled” sample.
